(19) United States
(12) Patent Application Publication
(10) Pub. No.: US 2014/0220196 A1
(43) Pub. Date: Aug. 7, 2014

(54) Temperature Controlled Cooking Device, Control System, and Method

(71) Applicant: Restaurant Technology, Inc., Oak Brook, IL (US)

(72) Inventor: Balagru K. Veloo, Gurnee, IL (US)

(73) Assignee: Restaurant Technology, Inc., Oak Brook, IL (US)

(21) Appl. No.: 13/760,392

(22) Filed: Feb. 6, 2013

(51) Int. Cl. A47J 37/06; A23L 1/01

(52) U.S. Cl. CPC A47J 37/0611; A23L 1/01
USPC 426/233; 99/331

(57) ABSTRACT

A device and method are provided for measuring and controlling temperatures of a cooking platen. In particular, according to the invention, a surface temperature sensor is configured to measure a temperature on or proximate to a cooking surface of the platen and an internal temperature sensor is provided to measure an internal temperature of the platen, which may be proximate to the hottest location in the platen, i.e., the opposite surface of an insulated platen or the core of an uninsulated platen. The surface temperature sensor provides an accurate reading of the actual cooking surface temperature, while the internal temperature sensor provides a better indication of total heat energy stored in the platen, being less sensitive to surface fluctuations. A microprocessor controls the rate of heat energy addition to the platen based on information from both temperature sensors.

### FIELD OF THE INVENTION

The present invention relates to temperature control systems and methods. More particularly, it relates to control systems and methods for automatically maintaining the cooking surface temperature of a cooking platen by controlling a rate of heat addition to the platen based on a measured temperature of the platen.

### BACKGROUND OF THE INVENTION

In high-volume, quick-service restaurant grilling of food items, it is desirable to maintain a grilling platen cooking surface at a substantially constant temperature in order to provide a substantially uniform cooked food product to customers. Thus, grilling platen temperature control systems are typically used in contact grills. Existing temperature control systems include temperature sensors at or near the cooking surface, which provide cooking surface temperature data to an electronic controller, which may be a hard-wired controller or a programmable controller such as a microprocessor. When the controller receives cooking surface temperature readings below a desired cooking temperature, it directs a heat source to provide heat to the platen. In one version of this type of control, the larger the difference between the measured cooking surface temperature and the desired cooking surface temperature, the faster the heat addition rate. These types of control systems have drawbacks, including in adjusting for sudden fluctuations in cooking surface temperature, typically due to initial contact with a cold food item, especially a frozen food item. The undesirable result is that the cooking surface temperature may overshoot the optimum temperature more than what is desirable, resulting in less product uniformity.

Another typical problem with existing grilling platen temperature control systems occurs during startup. It is common for the grilling platens used in the high-volume, quick-service food industry to be quite massive, and may comprise a platen of tool steel ¼-½′ thick, for example. This provides the platen with a high heat capacity (which is sometimes also referred to as “thermal inertia” or “thermal mass”), so that the proportion of the total heat stored in the platen that is suddenly lost when initially contacting a frozen food item, for example, is relatively small, and the transient surface temperature effect discussed above is kept relatively local and brief in duration. One drawback to this type of massive grilling platen, however, is that its high heat capacity requires more energy for startup, and thus more time for a given heating power level of its heating elements, than would be required for a smaller platen. In addition, the goal of efficiency often demands turning cooking equipment on and off multiple times in a given day, rather than wasting energy by continuing to power the heating elements of the cooking equipment during periods of non-use. Consequently, a grilling platen frequently is started up before its interior has cooled to approximately ambient temperature following its previous operation, although its surface temperature may already be much closer to the ambient temperature, perhaps even differing from the ambient temperature by a small amount, including an amount no more than a margin of error of the temperature sensor. The controller might then interpret that a cold startup is occurring and provide more heat than is needed from the heating elements, again with the result of potentially overshooting the surface cooking temperature and potentially causing non-uniformity of cooked food product.

A need therefore exists for a cooking device having a platen cooking surface temperature control system that causes an appropriate amount of heat to be provided to a platen during start up and cooking operations, especially when a cold food item initially contacts the cooking surface of the platen, and at startups occurring when the platen has not yet fully cooled from its previous use.

### BRIEF SUMMARY OF THE INVENTION

In accordance with one aspect of the present invention, a cooking platen is provided that includes a temperature control system that causes an appropriate amount of heat to be provided at an appropriate rate to a platen during start-up and cooking operations, based on data including both a measured surface temperature and a measured interior temperature of the platen. In one embodiment, the temperature control system controls the heating power of a heat source based on an estimate or calculated determination of the heat energy stored in the platen, which may be an estimate or calculated determination of the total heat energy stored in the platen, determined from data including the measured interior temperature.

In accordance with one aspect of the invention, a temperature-controlled cooking device is provided. The temperature-controlled cooking device includes a cooking platen having a cooking surface, a heat source associated with the cooking platen for directing heat energy into the cooking platen, at least one surface temperature sensor configured to measure a temperature at a location on or proximate to the cooking surface, at least one internal temperature sensor configured to measure a temperature in the interior of the cooking platen and a controller configured to receive at least one measurement of the temperature of at least one platen surface location from the at least one surface temperature sensor and at least one measurement of the temperature of at least one platen interior location from the at least one internal temperature sensor, the controller being programmed to determine an output power level for the heat source from the input data including the surface and interior temperature measurements and to control the heat source according to the determined output power level.

In accordance with another aspect of the invention, the input data further includes at least one parameter selected from a past platen interior temperature measurement, a time interval between platen interior temperature measurements, a measured time rate of change of platen interior temperature, a past platen surface temperature measurement, a time interval between surface temperature measurements, a measured time rate of change of platen surface temperature, a sample statistic of a plurality of platen surface temperature measurements, a sample statistic of a plurality of platen interior temperature measurements, an expected surface temperature given a measured platen interior temperature, an expected platen interior temperature given a measured platen surface temperature, a current power level of the heat source, a past power level of the heat source, a depth of the at least one surface location, a horizontal position of the at least one surface location, a depth of the at least one interior location, a horizontal position of the at least one interior location, a thermal conductivity of the platen, a specific heat of the platen, a thickness of the platen, an area of the cooking surface, a volume of the platen, a density of the platen and a weight per unit area of the platen.

In accordance with another aspect of the invention, the cooking device further includes a thermally insulated barrier at least substantially covering a surface of the cooking platen generally opposite the cooking surface. Typically, the cooking surface is flat or generally flat although the surface can be any desired shape. The platen may comprise opposed cooking surfaces.

Any suitable type of surface and internal temperature sensors may be utilized in accordance with the invention. Such sensors may be located at or proximate to the platen surface. A plurality of surface temperature sensors may be utilized, configured to measure temperatures at or proximate to a plurality of different locations on the cooking surface. The plurality of different locations on the cooking surface can be as desired and may be in a predetermined array, which may be a predetermined uniform array.

In accordance with another aspect of the invention, the heat source comprises a heating element configured to transfer heat energy. The heat transfer may be by any mode, including, for example, conduction, radiation and convection. Typically, the heat source is configured to transfer heat energy at the cooking surface and the platen is configured to conduct at least some of the heat energy to the cooking surface through the interior of the platen.

A method of controlling the cooking surface temperature of a cooking platen is provided. The method includes providing a cooking device as previously described and causing the controller to receive at least one temperature measurement of at least one platen surface location from the at least one platen surface temperature sensor and at least one temperature measurement of at least one platen interior location from the at least one platen internal temperature sensor, determining an output power level for the heat source from input data, the input data including the platen surface and platen interior temperature measurements and controlling the heat source according to the determined power level.

In accordance with another aspect of the invention, the method of controlling the cooking surface temperature of a cooking platen having a thermally insulating barrier at least substantially covering the surface of the cooking platen generally opposite or opposed to the cooking surface.

In accordance with another method aspect of the invention, the cooking surface comprises first and second cooking surfaces that are generally opposite or opposed to each other.

In accordance with another aspect of the invention, a method of cooking a food item on a heated platen surface is provided. The method includes providing a cooking device as described previously, causing the controller, in response to an instruction to start up the cooking device, to receive at least one initial measurement of the platen temperature of at least one platen surface location from the at least one platen surface temperature sensor and at least one initial measurement of the platen temperature of the at least one platen interior location from the at least one internal platen internal temperature sensor, to determine at least one startup power level for the heat source based on the initial platen surface and interior temperature measurements, directing the heat source to add heat to the interior of the cooking platen at the at least one startup power level, changing the power level of the heat source to a steady state power level when the controller determines that the at least one platen internal temperature measurement and/or the total heat energy stored in the platen has reached a predetermined final startup threshold, the steady state power level being an output power level at which the temperature of the platen cooking surface is maintained at a predetermined constant ready-for-cooking temperature, placing the food item in contact with the platen cooking surface when the at least one platen surface temperature sensor indicates a temperature of the platen cooking surface of approximately the ready-for-cooking temperature, and causing the controller to direct the heat source to continue to supply heat to the platen in an output power level profile in accordance with a predetermined cooking routine for the food item to cook the food item.

In accordance with another aspect of the method, at least one startup power level comprises a plurality of startup power levels resulting in an average startup power level greater than the steady state power level.

In accordance with another aspect of the method of the invention, the method further includes continuously changing the startup power level from the time at which the controller is instructed to startup the cooking device to the time at which the controller determines that the amount of heat energy stored in the platen has reached the final startup threshold, based on continuous input to the controller from the temperature sensors.

In accordance with another aspect of the invention, the method may further include causing the controller to automatically detect that a food item to be cooked is in contact with the platen surface from a sudden drop in the at least one platen surface temperature measurement, and to automatically direct the heat source to commence the predetermined cooking routine for the food item when the food item is detected.

In accordance with another aspect of the invention, the method may further include causing the controller to automatically detect that a food item to be cooked is in contact with the platen when the at least one platen surface temperature sensor detects a temperature that is lower than an expected surface temperature given data including a sensed platen internal temperature.

In accordance with another aspect of the method, the method further includes providing a plurality of platen surface temperature sensors, configured to measure platen surface temperatures at or proximate to a plurality of different locations on the cooking surface and causing the controller to automatically detect that a food item to be cooked is in contact with the platen when the platen surface temperature sensors detect at least one surface temperature that differs from the at least one other surface temperature by more than a predetermined amount.

### BRIEF DESCRIPTION OF THE DRAWINGS

FIG. 1 is a perspective view of a clamshell grill cooking device in accordance with one embodiment of the invention.

FIG. 2 is an elevation view of a cooking platen of the cooking device depicted in FIG. 1, illustrating a ready-for-cooking steady thermal state of the platen.

FIG. 3 is an elevation view of a cooking platen of the cooking device depicted in FIG. 1, illustrating a transient power-off thermal state of the platen.

FIG. 4 is an elevation view of an alternative cooking platen illustrating a ready-for-cooking steady thermal state of the platen.

FIG. 5 is an elevation view of the alternative cooking platen depicted in FIG. 4, illustrating a transient power-off thermal state of the platen.

FIG. 6 is a block diagram illustrating a feedback process for controlling the temperature of a cooking platen according to one aspect of the invention.

FIG. 7 is an elevation view of a cooking platen illustrating a progression of slow-startup temperature profiles.

FIG. 8 is a graph illustrating a transient intermediate start-up thermal state in which the energy stored in a platen is the same as the energy stored in the platen at a ready-for-cooking steady thermal state, the energy stored in each case being depicted as an area beneath a respective temperature profile curve.

FIG. 9 is a plan view of an alternative cooking platen in accordance with another embodiment of the invention.

### DETAILED DESCRIPTION OF THE INVENTION

In accordance with the present invention, a cooking device and method for improved platen temperature control are described in this section with reference to the accompanying Figures. In particular, cooking devices according to the invention include a temperature sensor located proximate to a cooking surface of a platen and a temperature sensor located in the interior of a platen. The surface temperature sensor provides a direct indication of the actual cooking surface temperature, which is of primary interest when cooking food items using contact heat from a platen. In addition, the surface temperature sensor is more sensitive to transient temperature fluctuations at or near the cooking surface, due especially to initial contact of a cold food item on the cooking surface, whose effects are more attenuated at the location of the interior temperature sensor. Therefore, the two temperature sensors of the present invention advantageously complement each other, in that the surface temperature sensor indicates whether the cooking surface temperature is at, above, or below its target cooking temperature, and if the cooking surface temperature is below its target temperature, the interior temperature sensor provides a relatively stable indicator of the total heat stored in the platen, permitting a controller to determine whether it is appropriate to add heat to the platen, and if so at what rate, to avoid overshooting the target cooking temperature by more than what is desirable.

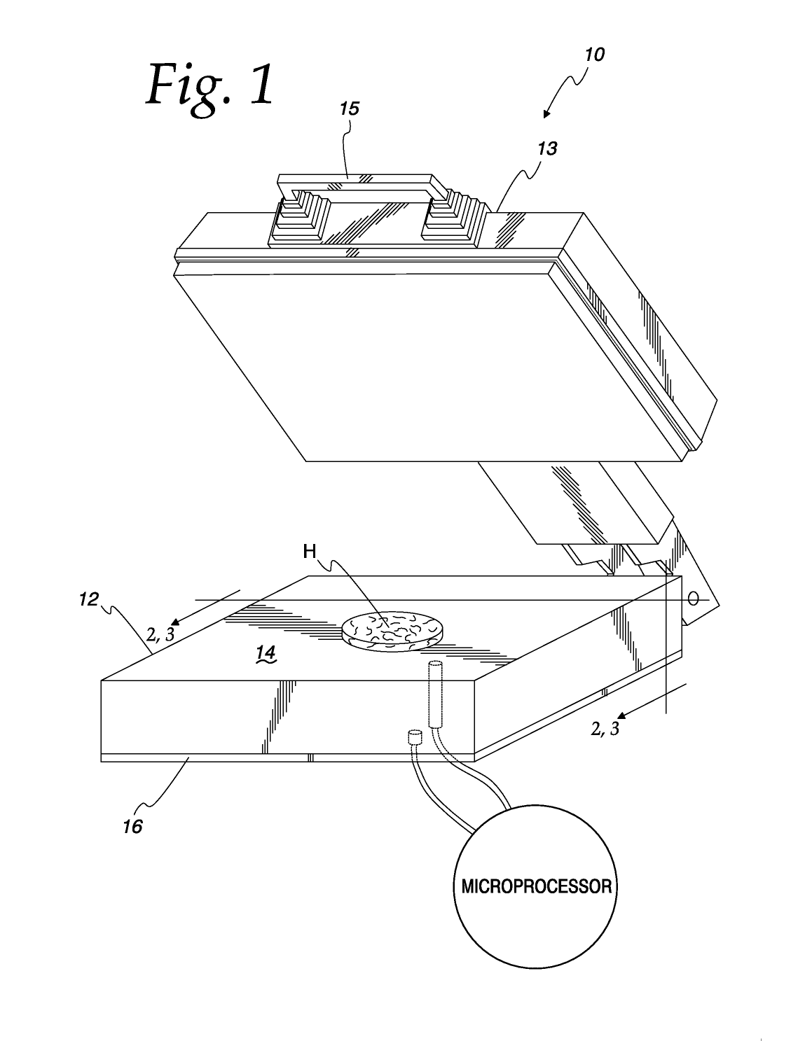

With reference to FIGS. 1-3, one embodiment of a cooking device according to the invention is described and illustrated. In FIG. 1, the embodiment is depicted in perspective view as cooking device 10. Cooking device 10 includes a platen 12 having an exposed cooking surface 14. Platen 12 may be composed of any suitable material, which may for example be selected for desirable density and thermal properties, including for example thermal conductivity and specific heat. Some non-limiting examples of suitable materials include tool steel, stainless steel, copper, aluminum, nickel, zinc, and their alloys. Platen 12 may be a uniform, unitary body, or the bulk of platen 12 may be composed of one metal, while platen 12 is clad with another metal. Alternatively, platen 12 may comprise stacked layers to take advantage of the desirable properties of multiple materials. A common example of a multiplayer platen comprises a thick layer of steel, desirable for its high thermal mass and thus temperature stability with respect to time, bonded to a thin layer of aluminum on a cooking side, desirable for its high thermal conductivity and thus temperature uniformity throughout its volume.

In the embodiment illustrated in FIGS. 1-3, an opposite surface 20 of platen 12 substantially covered by an insulating barrier 16, to prevent heat energy from electrical heating elements 18 adjacent opposite surface 20 from wastefully escaping through a non-cooking surface of platen 12. However, the sides of platen 12 typically comprise a much smaller area than cooking surface 14 and the opposite surface, so that any potential energy saving benefit of insulating the sides may be outweighed by the drawback of food residue potentially becoming trapped between any insulation and the sides of platen 12. It will also be noted that, while electrical resistance heating elements are depicted in the illustrated embodiments, other heating mechanisms suitable for heating a platen are also within the scope of the invention, including but not limited to flame, irradiative, convective, inductive, and phase change (e.g. steam to liquid) heating modes, for example. In the case of a heating mechanism not involving solid-to-solid contact, such as flame, irradiative, convective, and phase-change heating, instead of an insulating barrier directly adjacent to opposite surface 20, an insulating barrier on the side or sides of the heat source that do not face platen 12 is likely desirable.

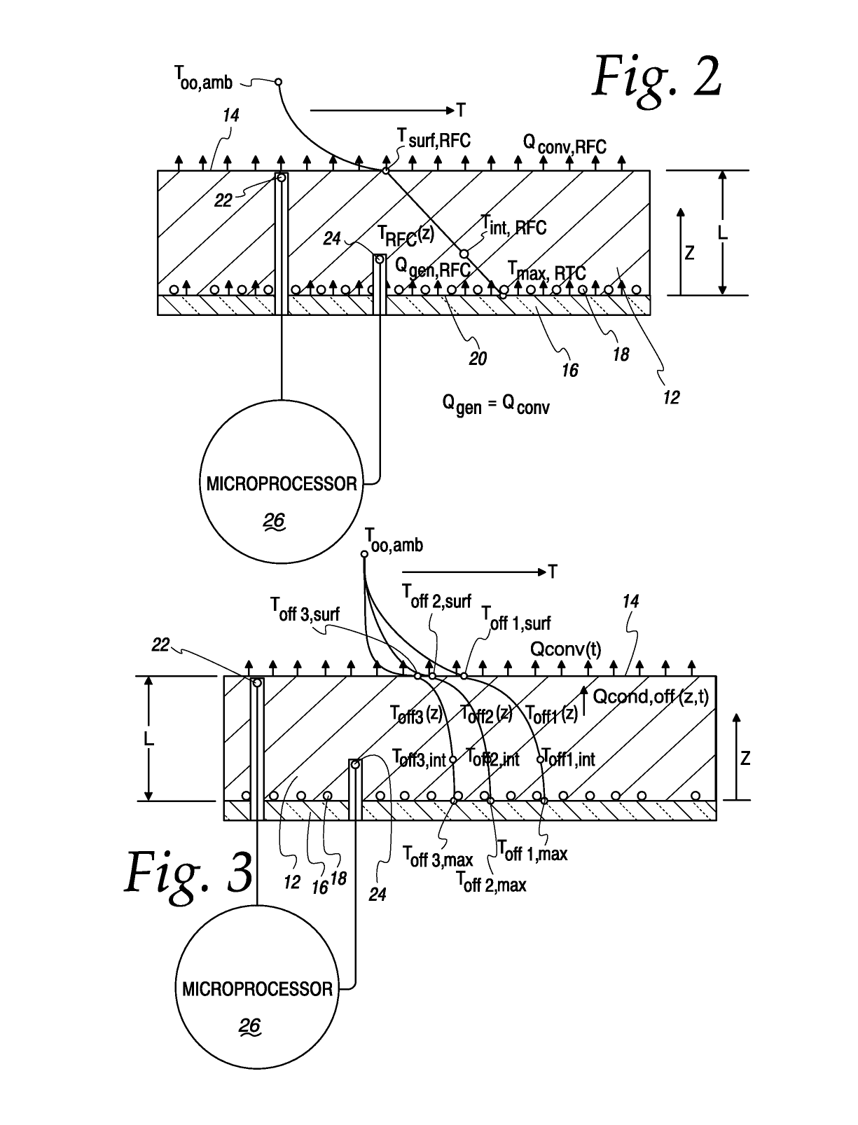

In the depicted example, cooking device 10 is a clamshell grill of which platen 12 is a lower platen, the clamshell grill also including an upper platen 13 which may be raised onto and lifted from platen 12 by grasping a handle 15. Turning to FIG. 2, a temperature profile across the thickness of platen 12 is depicted for a steady state in which cooking surface 14 is heated up to the desired cooking temperature and ready to contact a food item to be cooked (referred to herein as the “ready-for-cooking steady state,” “RFC steady state,” or simply “RFC”). It will be understood that the temperature variable “T” represented by the temperature curves in the Figures increases to the right, as indicated by the legend arrow in each appropriate Figure, designated T.

In the steady state of platen 12 illustrated in FIG. 2, heating elements 18 in platen 12 are steadily generating heat Q_{gen, RFC}, which, due to the law of conservation of energy, must equal the rate of convective heat transfer Q_{conv, RFC} flowing from cooking surface 14 at a surface temperature T_{surf, RFC} toward ambient air at a temperature remote from the cooking surface of T_{∞,amb}. For simplification purposes, Q_{gen, RFC} is herein assumed to initiate uniformly and unidirectionally from the opposite surface 20 of platen 12 and flow toward cooking surface 14, resulting in a steady-state temperature profile T_{RFC}(z) that is a straight line decreasing from a maximum temperature T_{max, RFC} at opposite surface 20 to a minimum temperature at cooking surface 14 (already identified as T_{surf, RFC}), and passing through an internal temperature T_{int, RFC}, as a linear function of the variable “z” representing the vertical distance from opposite surface 20. Because insulating barrier 16 generally constrains heat conduction in platen 12 to flow upward toward cooking surface 14, the foregoing is believed to be a reasonable approximation of actual conditions, especially at locations in platen 12 removed a sufficient distance from heating elements 18 and from the edges of platen 12, where some heat flows out of the platen laterally.

Thus, a surface temperature sensor 22 proximate to cooking surface 14 and an internal temperature sensor 24 remote from cooking surface 14 and generally located at the depth where internal temperature T_{int, RFC} is measured, both configured to submit measured temperature data to a programmable controller 26 (in place of which a hard-wired or other type of electronic controller may be substituted as desired), are preferably located in platen 12 sufficiently remotely from heating elements 18 so that any multidirectional heat flow effects may be ignored. Similarly positioned temperature sensors may also be incorporated into upper platen 13, though not shown in FIG. 1, for independent temperature control of upper platen 13 in accordance with substantially the same systems and methods as described herein with respect to lower platen 12.

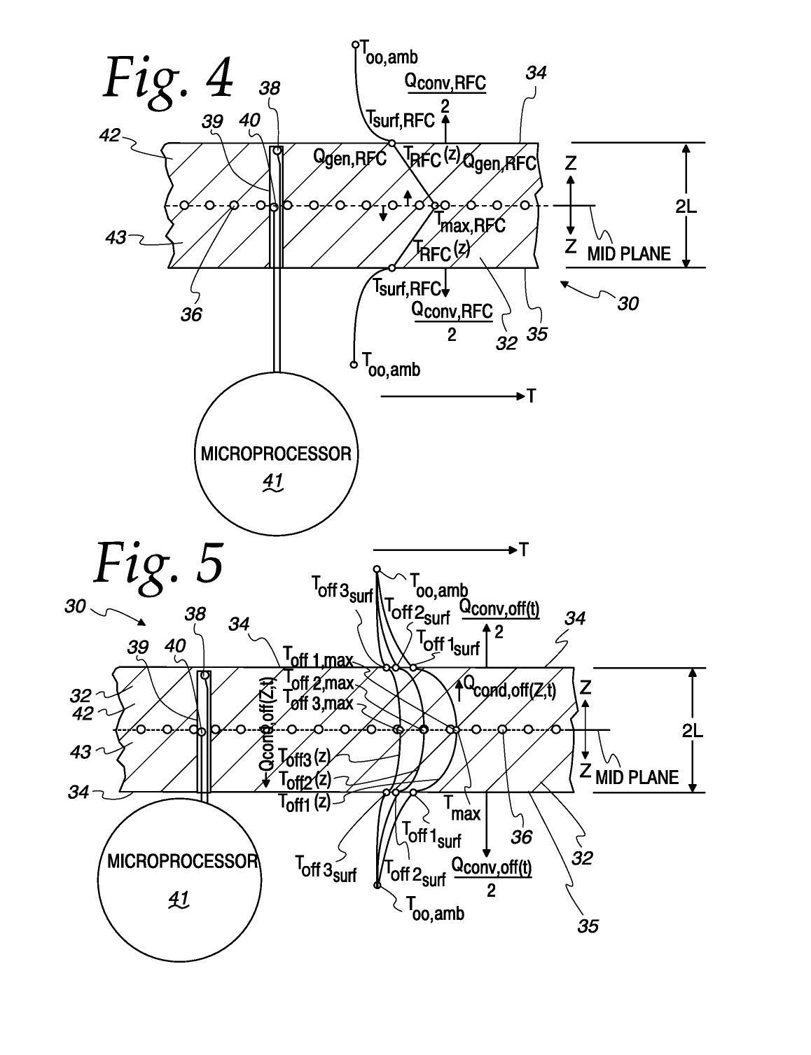

Depicted schematically in FIG. 3 is the same platen 12 as shown in FIGS. 1 and 2, but in a transient thermal state in which heating elements 18 have been turned off, but platen 12 has not yet uniformly cooled to ambient temperature T_{∞,amb}. Overlaying platen 12 are temperature profile curves T_{off1}(z), T_{off2}(z), and T_{off3}(z) representing the respective temperature profiles across the thickness of platen 12 at successive times that may be referred to as t₁, t₂, and t₃ (not shown), t₁ being an initial time at which heating elements 18 are turned off, and t₂ and t₃ successively later times. Curves T_{off1}(z), T_{off2}(z), and T_{off3}(z) have respective maximum temperatures T_{off1max}, T_{off2max} and T_{off3max} at opposite surface 20 and minimum temperatures T_{off1surf}, T_{off2surf}, and T_{off3surf} at cooking surface 14, all of which decrease over time. In this transient state, unlike in the steady state depicted in FIG. 1, the temperatures throughout platen 12 are not constant, but rather platen 12 is cooling everywhere. Also, at a given time t after t₁, a conductive heat transfer Q_{cond, off}(z, t) within platen 12, is generally not uniform but varies across the thickness of the platen, generally increasing in magnitude as z increases. Likewise, after time t₁, the downward slope of the temperature profile, which is directly proportional to the heat transfer rate at a location within the platen, generally increases in magnitude in the direction of increasing z. In simplified terms, this is because each segment of the platen must have a larger heat flux Q_{cond, off}(z, t) flowing out of the segment in the direction of increasing z, (i.e., towards cooking surface 14) than into the segment (i.e., from the core or insulated opposite surface 20), and thus a larger temperature gradient |∂T/∂z| (not labeled) at its cooler side, conductive heat flux being directly proportional to temperature gradient, resulting in the curved profiles of T_{off2}(z) and T_{off3}(z) depicted in FIG. 3.

Of course, the temperature profiles in the figures are not intended to be drawn to scale. However, one skilled in the art will understand that the internal temperature T_{off,int}(t) at the depth of internal temperature sensor 24 decreases on average by a greater step over each successive time interval than the minimum (cooking surface) temperature T_{off,surf}(t) at cooking surface 14, as illustrated visually in FIG. 3 by the greater separation between the temperature profile curves at and near opposite surface 20 than at and near cooking surface 14. This is because, at all times during cooling, the internal temperature T_{off,int}(t) differs more greatly from the target ambient temperature that will ultimately be reached throughout the platen once steady state is attained, and T_{off,int}(t) must therefore decrease more quickly than T_{off,surf}(t) for both temperatures to reach ambient temperature at the same time, which occurs when a fully cooled steady state is attained. The present inventors believe that, as a result of this phenomenon, any error in measurement of T_{off,surf}(t) is compounded into a larger error in T_{off,int}(t) when extrapolating a temperature curve to opposite surface 20, whereas, conversely, any error in the measurement of T_{off,int} (t) is reduced to a smaller error in T_{off,surf}(t) when extrapolating a temperature curve to cooking surface 14. The foregoing is an additional reason why, in accordance with the present invention, it is advantageous to use a temperature measurement from interior temperature sensor 24 to estimate the temperature profile in platen 12, or if measurements from both interior temperature sensor 24 and cooking surface temperature sensor 22 are used, to err closer to the temperature curve predicted by the measurement from temperature sensor 24 than to that predicted by the measurement from temperature sensor 22.

Turning to FIGS. 4 and 5, an alternative cooking device 30 is illustrated at a ready-for-cooking state and a transient, power-off state, respectively. Cooking device 30 includes a platen 32 having two opposed uninsulated surfaces 34, 35, one or both of which may be a cooking surface. Similarly to cooking device 10, cooking device 30 includes heating elements 36 and temperature sensors 38, 40, respectively located proximate to one of uninsulated surfaces 34 and to the core of platen 32, temperature sensors 38 and 40 being configured to transmit measured temperature data to a programmable microprocessor 41 (in place of which a hard-wired or other type of electronic controller may be substituted as desired). It will be noted that, in the embodiment illustrated in FIGS. 4 and 5, temperature sensors 38, 40 lie generally on the same vertical line. This arrangement allows both sensors 38, 40 to be conveniently accommodated in a single bore hole 39, while another possible advantage is the removal of any horizontal effects on temperatures at the measured surface and interior locations. The same generally vertically aligned configuration of an interior and a surface sensor may also be advantageously employed in the insulated platen embodiment described above.

From principles of symmetry, it will be understood that the temperature profile in each half 42, 43 of platen 32 is the same as that of an entire platen 12 of device 10 having half the thickness of platen 32, where twice the heat generation is provided, and the boundary conditions at surface 34 are the same as at surface 35. Such is the case at a ready-for-cooking steady state, a transient power-off state, and a transient power-on start-up state in which no food products are touching either surface 34, 35. Thus, a separate detailed analysis of the temperature profile in platen 32 is not necessary to apply the invention to devices and methods for attaining a ready-for-cooking state in an uninsulated platen.

Methods for efficiently controlling the heat addition supplied to a cooking platen to quickly bring the cooking surface temperature to a desired temperature, without excessive overshoot, will now be described for three basic scenarios, with reference to cooking device 10 as depicted in FIGS. 1-3, with the understanding that the same methods are applicable to cooking device 30 having an uninsulated platen 32 by simply providing about twice the heat generation that would be needed for an insulated platen 12 half its size. A first scenario is normal, cold startup of cooking device 10, a second scenario is startup after partial cool-down of cooking device 10, and a third scenario is detection of and reaction to a thermal shock, typically due to a cold/frozen food item to be cooked initially contacting cooking surface 14.

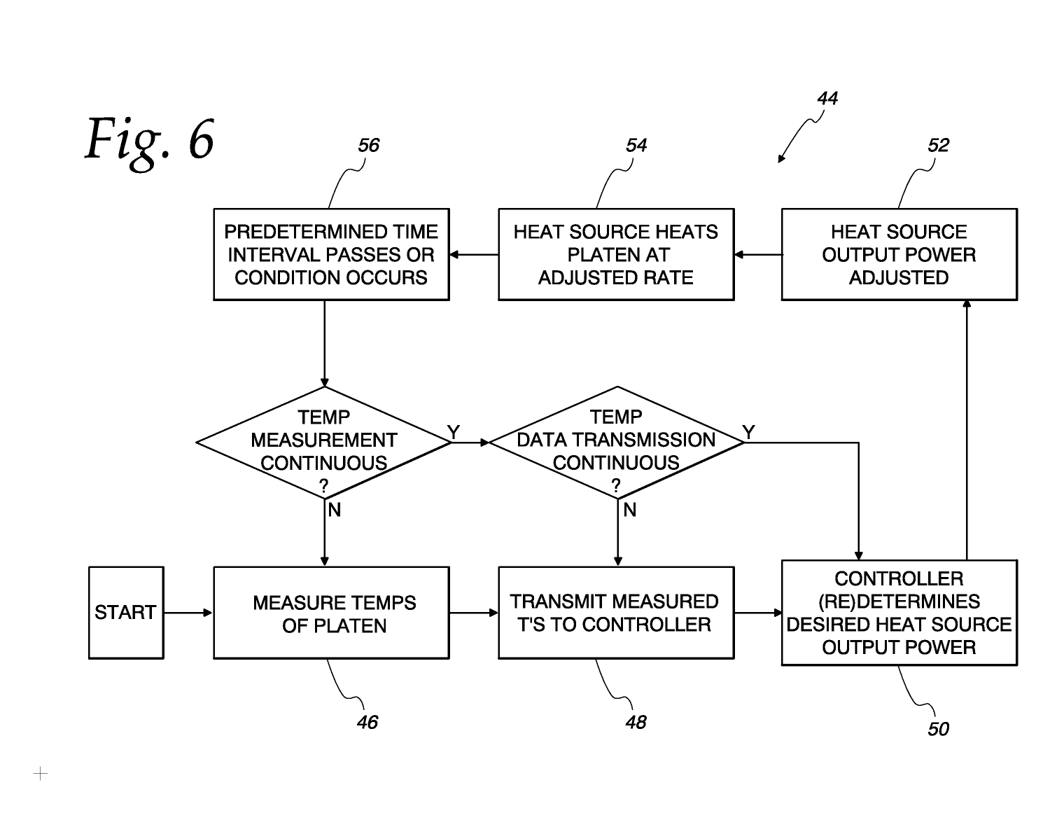

A generalized feedback process 44, illustrating a looped sequence of steps that is applicable to all three scenarios, is depicted in FIG. 6. In particular, in an initial measurement step 46, temperatures of a platen at plural locations are measured by suitable sensors. Measurement step 46 may occur continuously, periodically, or whenever certain conditions occur, as explained in more detail below with respect to the feedback aspect of process 44. The measured temperatures are transmitted to and received by an electronic controller in a monitoring step 48. Like measurement step 46, monitoring step 48 may occur periodically at given time intervals, continuously, or upon certain conditions. Optionally, monitoring step 48 may entail cumulatively storing measured temperatures in a memory, to be called up by the controller as needed. The memory, for example, may retain a history of measured temperatures going back a predetermined amount of time, discarding temperature data only when its age exceeds the predetermined amount of time, or it may simply retain the most recently stored temperatures, discarding the previously stored temperatures each time the memory is updated.

In a decision step 50, the controller determines, by implementing hardwired or programmed logic, whether and how to adjust the output heating power level of a heat source based on data including at least the most recently measured and monitored surface and interior temperatures, which are either input directly from the sensors or called up from the memory. (To simplify the present description, controlling a heat source is described in terms of controlling its output heating power level, i.e., the actual heat generated by the heat source, not in terms of the input power to the heat source, which may be higher than its output heating power due to less than 100% efficiency in converting input power to heating power. Thus, for purposes of this application, the “power” of a heat source may be assumed to refer to its output heating power, as heat energy generated per unit time, unless specifically stated as “input power” or “power to” the heat source.) Other measured variables and fixed properties that may be used by the controller to execute its decision process include but are not limited to past surface and/or interior temperature measurements; a time interval between any past temperature measurements and current temperature measurements; a current and/or past time rate of change of the interior and/or surface temperature; an expected surface temperature given a measured interior temperature; an expected interior temperature given a measured surface temperature; a current and/or past output power level of the heat source; a depth in the platen of the surface location at which the surface temperature is measured; a horizontal position of the surface location; a depth in the platen of the interior location at which the interior temperature is measured; a horizontal position of the interior location; and physical properties of the platen including but not limited to its dimensions, density, weight per unit area, thermal conductivity, and specific heat. In one embodiment, in which a cooking device includes temperature sensors configured to measure temperatures at more than two depths in the platen (not shown in the Figures), input data for decision step 50 may include additional temperature measurements at each additional depth, enabling the controller to extrapolate a temperature profile throughout the thickness of the platen with still more accuracy and precision.

In general, if the surface temperature is already at or near the desired steady-state RFC temperature, the controller should be wired or programmed to determine that the heat source shall be maintained at a continuous steady-state RFC power level, pulsed on and off, or otherwise controlled in such a manner as to provide an average power level equivalent to the continuous steady-state RFC power level. If the measured surface temperature is significantly above the RFC temperature, the controller will determine that the heat source shall either be turned off or adjusted to a continuous or average power level below the steady-state RFC power level. Also, since the measured surface temperature should not typically significantly exceed the RFC temperature during normal operation, the controller may also determine that an alert shall be generated. If, on the other hand, the surface temperature is significantly lower than the ready-for-cooking surface temperature, then the controller will check the interior temperature measured at the same instant, and determine whether the interior temperature is significantly higher than expected given the surface temperature for a normal startup process. If the interior temperature is close to the expected value, then the controller will determine that the output power level of the heat source shall be maintained at or adjusted to a normal startup level predefined for the pair of measured temperatures. If, however, the interior temperature is significantly higher than the expected value, then the controller will determine that the output power level of the heat source shall be maintained at or adjusted to a level lower than the normal startup level predefined for the pair of measured temperatures. This lower than normal power level accounts for the fact that the actual amount of heat energy stored in the platen, which is more reliably predicted by the interior temperature (due to its relative insensitivity to the transient effects of surface conditions such as the placement of a cold food item in contact with the cooking surface), is higher than expected given the measured surface temperature. Therefore, less heat source output power is appropriate than during normal startup for the measured low surface temperature.

Following decision step 50, the controller causes the power level of the heating elements to be adjusted as appropriate in a control step 52. An implementation step 54 entails the heating elements heating the platen at the adjusted output power level (either zero, a positive continuous rate, or a pulsed output), which continues either through a predetermined time interval or until the occurrence of a predefined condition, such as a measured temperature reaching a predetermined threshold. The passage of the time interval or occurrence of the predefined condition is designated as a feedback trigger step 56.

Following implementation step 56, the cycle feeds back into one of measurement step 46, monitoring step 48, and decision step 50. For example, the temperature sensors performing measurement step 46 may only take temperature measurements whenever instructed by the controller to do so, rather than continuously or periodically over fixed time intervals, in which case the cycle may feed back into measurement step 46 by the controller directing the sensors to take temperature measurements again upon completion of feedback trigger step 56. In another embodiment, measurement step 46 may occur continuously, but the temperature sensors may transmit the measured temperature data to the controller in monitoring step 48 only when instructed to do so by the controller, in which case the cycle may feed back into monitoring step 48 by the controller directing the sensors to transmit the current temperature measurement to the controller upon completion of implementation step 56. In the previous two embodiments, the controller may not require a memory, as temperature measurement data may be simply input directly into the controller's decision algorithm as it is received by the controller, rather than stored in a memory until called up. In still another embodiment, measurement step 46 and monitoring step 48 both occur continuously, so that current temperatures are continuously being stored in a memory of (or in communication with) the controller, in which case the cycle may feed back into decision step 50 by the controller calling up the current interior and surface temperature measurements from a memory upon completion of feedback trigger step 56.

In one embodiment, before feedback process 44 is carried out for any of the three scenarios, it is advantageous to determine the ready-for-cooking steady-state values of heat generation Q_{gen, RFC} and interior temperature T_{int, RFC} for a given desired cooking surface temperature T_{surf, RFC}, and to program those three values into controller 26, in accordance with the following calibration method. Q_{gen, RFC} at steady state is approximately equal to the steady state rate of convective heat transfer, indicated in FIG. 2 as Q_{conv, RFC}, to the ambient through cooking surface 14, as explained above. An initial working estimate of Q_{gen, RFC} at ready-for-cooking steady state may thus be obtained by analytically calculating a convective heat transfer rate Q_{conv, RFC} at ready-for-cooking steady state according to the following equation (1):

Q_{conv,RFC}=hA(T_{surf,RFC}−T_{∞,amb}) (1)

where “h” is the coefficient of unforced (also referred to as “natural” or “free”) convection for the air around platen 12, and “A” is the area of cooking surface 14. Then, the actual value of Q_{gen, RFC} at the ready-for-cooking steady state for a given platen 12 may be determined experimentally, starting by supplying Q_{gen, RFC} at the calculated value of Q_{conv, RFC}, allowing sufficient time for platen 12 to reach a steady state, measuring the actual temperature of cooking surface 14, (also referred to as “T_{surf}” in this description), and then gradually increasing or decreasing the heating power output of heating elements 18 until a periodically measured value of T_{surf} reaches and remains at or near the desired cooking surface temperature T_{surf, RFC}, at a constant output power level. For purposes of cooking a frozen hamburger patty, T_{surf, RFC} may for example be between about 163° C. (325° F.) and about 204° C. (400° F.). Once the ready-for-cooking steady state is attained and verified, the reading of interior temperature sensor 24 is recorded as T_{max, RFC}.

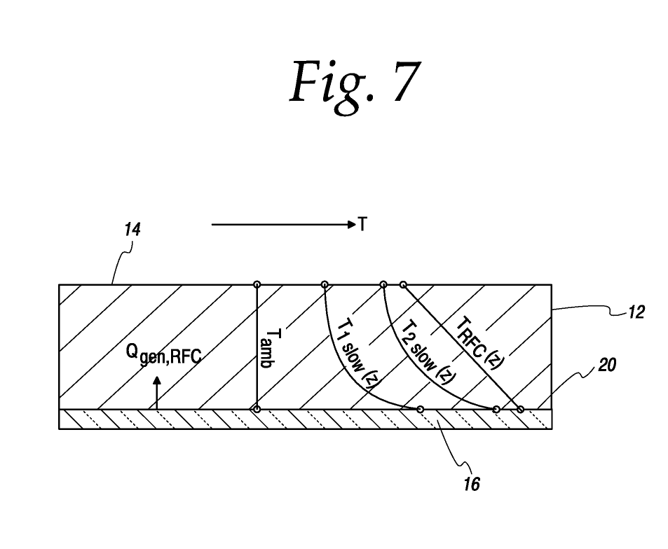

In the normal, cold startup scenario, platen 12 is not in contact with any food items and initially at the ambient temperature throughout its thickness. When cold startup is completed, platen 12, still not in contact with any food items, will be in the steady-state, ready for cooking condition depicted in FIG. 2, with an approximately uniformly sloped temperature profile. Steady state could subsequently be attained simply by supplying the steady state heating output power level determined by the calibration method described above, and then waiting for T_{surf} measured by sensor 22 to reach T_{surf, RFC}. Successive temperature profile curves for this reliable but relatively slow method of heating up platen 12 are illustrated in FIG. 7, designated as T_{amb}, T_{1slow}(z), T_{2slow}(z), and T_{RFC}(z), with temperature sensors, controller, and heating elements omitted for ease of illustration. It will be noted that as platen 12 heats up, before RFC steady state is reached, the temperature profile curves are concave right. This is because platen 12 is heating up everywhere, and therefore each segment of platen 12 has more heat entering it than exiting it in the positive z direction, towards cooking surface 14, in contrast to FIG. 3 illustrating passive cooling, where the opposite is true and the profile curves are concave left.

It may be desirable to reach steady RFC state more quickly than in the case of steadily supplying heat at Q_{gen, RFC} from the initial cold state of the platen until the moment that steady RFC state is reached. In that case, according to one cold startup method of the present invention, heating elements 18 initially add heat at a rate Q_{gen, startup} higher than Q_{gen, RFC} until the total heat energy stored in platen 12 is approximately equal to the energy stored at ready-for-cooking steady state, and then the heating output power is reduced to Q_{gen, RFC} (either gradually or instantaneously), allowing the platen temperature profile to stabilize to that shown in FIG. 2.

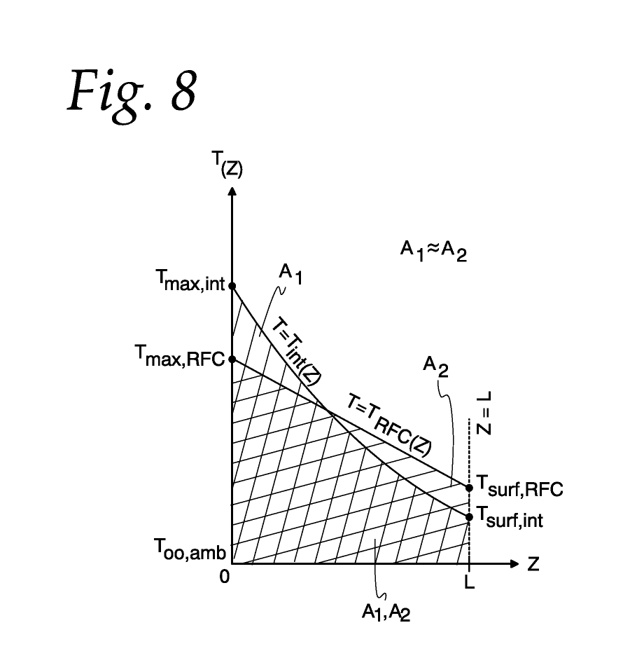

For purposes of this embodiment, heat energy stored (generally “HE_{stored}”, and at RFC, “HE_{stored, RFC}”) in platen 12 is defined as the amount of heat energy that must flow out of platen 12 for the temperature of platen 12 to uniformly reach T_{∞,amb}, which is proportional to the area between the curve of the temperature profile of platen 12 and the Z-axis line at T_{∞,amb}, as illustrated in FIG. 8 and explained in more detail below with reference to equation (3). It has already been noted that, at the ready-for-cooking steady state, the temperature profile of platen 12 is a straight line as depicted in FIG. 2. On the other hand, when heat energy is added to platen 12 more quickly to reach an intermediate transient state in which the same amount of heat is stored in platen 12 as at steady state, the temperature profile will be curved with a higher maximum temperature T_{max, int}>T_{max, RFC} and a lower minimum (cooking surface) temperature T_{surf, int}<T_{surf, RFC} as illustrated in FIG. 8, where the respective RFC and intermediate transient state temperature profiles T=T_{RFC}(z) and T=Tᵢₙₜ(z), defining partially overlapping areas A₁ and A₂, respectively, of equal size, are shown on the same graph. When intermediate transient state temperature profile T=Tᵢₙₜ(z) is attained and then the output heating power of heating elements 18 is reduced to the steady state value of Q_{gen, RFC}, the temperature profile will eventually level off to the straight line T=T_{RFC}(z). T_{surf} will reach T_{surf, RFC} more quickly in this manner than by simply supplying heat at a rate equal to Q_{gen, RFC} from a cold state. However, it will be noted that the rate of heat loss from convection (not shown in FIG. 6) is lower at the intermediate transient state than at the ready-for-cooking steady state, due to T_{surf, int} being lower than T_{surf, RFC}. Therefore, the total heat energy stored in platen 12 will continue to increase from its RFC value until T_{surf} reaches T_{surf, RFC}. Consequently, one skilled in the art will understand that T_{surf} will then temporarily rise above (“overshoot”) T_{surf, RFC} before the RFC steady state may be attained, because the rate of convective heat loss must at some point exceed the rate of heat addition for platen 12 to release the excess heat energy that it gained during the time interval between the intermediate transient state and the time at which T_{surf} first reaches T_{surf, RFC}. In general, the greater the difference between Q_{gen, startup} and Q_{gen, RFC}, the faster T_{surf} will reach T_{surf, RFC}, and the larger the overshoot will be. A desired value of Q_{gen, startup} may thus be selected, for example, by experimentally determining the start-up times and overshoots for a plurality of values of Q_{gen, startup}, and choosing the value with the fastest start-up time resulting in an overshoot less than or equal to a maximum desired overshoot. Alternatively, overshoot may be minimized or even avoided altogether by decreasing the output power of the heat source from Q_{gen, startup} to Q_{gen, RFC} when the heat energy stored in platen 12 reaches a predetermined intermediate heat stored value that is lower than HE_{stored, RFC}—appropriate experiments may be conducted to determine an appropriate intermediate heat stored value that sufficiently reduces or eliminates overshoot as desired. It should also be noted that, instead of a constant Q_{gen, startup} that instantaneously changes to Q_{gen, RFC} at the intermediate transient state, the startup output power of the heat source may be provided at a stepped or continuous range of levels different from Q_{gen, RFC}, which may, for example, even include the output power level dipping below Q_{gen, RFC} at one or more times during startup, with the general understanding that for a fast startup, it is desirable for the average startup output power level of the heat source to be greater than Q_{gen, RFC}.

Although it may be possible to determine analytically for a particular value of Q_{gen, startup} the values of Tₘₐₓ and T_{surf} at which the total energy stored in platen 12 becomes equal to that stored at RFC steady state, and thus the intermediate transient state is reached, the solution would be very complicated. However, this challenge may be overcome by instead programming controller 26, 41 to periodically estimate HE_{stored}, the heat energy stored in platen 12 relative to its cold state at T_{∞,amb}, using a finite approximation method as follows. It will be noted that HE_{stored} is equal to the net heat energy gained (“HE_{gained}”) by platen 12 initially at its cold state. An approximation of HE_{gained} may be obtained by calculating the difference between the total heat energy added and the total heat energy lost through convection at a given point in time. Heat energy to platen 12 is equal to the rate of heat addition at startup multiplied by time elapsed, which may be written as Q_{gen, startup}*(t_{N}−t₀). Heat energy lost convectively may be estimated by summing estimated quantities of heat lost convectively during each of a plurality of time intervals [t=tₙ₋₁, t=tₙ], based on a platen surface temperature that is an average of the values of T_{surf} at the beginning and end of the respective time interval. Thus, after N time intervals of duration Δt=tₙ−tₙ₋₁, HE=_{stored} is approximated by the following equation (2):

HE_{stored}=HE_{gained}=Q_{gen,startup}*(t_{N}−t₀)−Σ_{(n=1,n=N)}hA[(T_{surf,n}+T_{surf,n-1})/2−T_{∞,amb}]*Δt (2)

When the resulting estimate of HE_{gained} is equal to HE_{stored, RFC}, the output power of the heat source may be reduced to Q_{gen, RFC}, after which the temperature profile in platen 12 will eventually stabilize to that shown in FIG. 2, at which time controller 26 may direct a signal, such as a light or sound, to alert an operator that platen 12 is pre-heated and ready for cooking. Further refinements to improve this start-up procedure may be determined experimentally. For example, the magnitude of the desired elevated start-up power level of heating elements 18 may be selected by testing a number of different elevated power levels, and determining which elevated power level achieves the most desirable combination of fast start-up time, small (if any) surface temperature overshoot, and low total energy consumed to reach steady cooking state. It may also be determined that a power level that continually decreases from an initial elevated start-up power level to the steady-state power level best optimizes the foregoing results, and the rate at which power decreases may itself be either constant or varying.

In the second scenario of startup after partial cool down of platen 12, unlike in cold startup, some amount of heat energy is already stored in platen 12 when heating elements 18 are initially reenergized. Therefore, to estimate the net amount of heat energy stored in platen 12, controller 26, 41 must not only calculate the difference between the total heat energy added to platen 12 and a summation of incremental convective heat losses, but also calculate the initial amount of heat energy stored in platen 12, and add this value to the difference between heat added and heat lost. The initial amount of heat energy stored in platen 12 (HE_{stored, i}) may be calculated by extrapolating the temperature profile across the thickness of platen 12 from the temperature measurements taken by temperature sensors 22 and 24, either by analytical methods or by reference to charts which may be stored in a memory of controller 26, and then evaluating or estimating the integral of the following equation (3):

∫ρAcₚ[T(z)−T_{∞,am}]dz=HE_{stored,i} (3)

over the interval from z=0 to z=L, where ρ is the density of the material of platen 12, A is the area of surface 14 and of opposite surface 20, cₚ is the specific heat of the material of platen 12, T(z) is the temperature of platen 12 as a function of location z in the platen, and HE_{stored, i} is the sought value of the heat energy stored in platen 12 in its partially cooled state before startup. If HE_{stored, i} is less than the heat energy stored in platen 12 at ready-for-cooking steady state, controller 26 directs input power to heating elements 18 to provide heating power equal to Q_{gen, startup} or some other output heating power level that is greater than Q_{gen, RFC}. Controller 26 then periodically monitors the approximate amount of heat energy stored in platen 12 according to the following equation (4):

HE_{stored}=HE_{stored,i}+HE_{gained} (4),

where HE_{gained} is calculated from equation (2). Once HE_{stored} is approximately equal to the heat stored in platen 12 at the ready-for-cooking steady state, the power of heating elements 18 may be reduced to the ready-for-cooking steady state level, following which controller 26 may direct a signal, such as a light, to alert an operator that platen 12 is ready for cooking, as soon as T_{surf} has stabilized at or near the desired cooking temperature.

In the third scenario of a sudden temperature fluctuation felt only near cooking surface 14 due to a cold food item initially contacting cooking surface 14, controller 26 will quickly detect that the difference between Tₘₐₓ and T_{surf} is significantly greater than at ready-for-cooking steady state. Controller 26 is then programmed to direct heating elements 18 to commence a cooking sequence which continues until the food item is cooked. For example, the cooking sequence may involve initially raising the power of heating elements 18 to a peak cooking level and then gradually decreasing the power level, to counteract the effect of the food item continuously heating up. Alternatively, the cooking sequence may simply involve raising the power of heating elements 18 to a cooking level and maintaining that cooking level until the food item is fully cooked, with the understanding that this will result in the temperature of cooking surface 14 increasing throughout the cooking process rather than remaining substantially constant, which may be acceptable depending on the cooking application.

At the end of a cooking sequence, controller 26 either detects that the food item is fully cooked based on a reading or series of readings of T_{surf} near the food item or determines that the food item is fully cooked based on its completion of the cooking sequence, in case the cooking sequence is memorized instead of or in addition to being feedback-controlled. Preferably, even if the cooking sequence is memorized, controller 26 nonetheless continues to receive temperature data from sensors 22 and 24. Then, if a temperature reading or sequence of readings diverges greatly from what is expected during the normal course of a cooking sequence, indicating the possibility that a food item is likely not actually in contact with cooking surface 14, but rather the initial sudden fluctuation in cooking surface temperature may have been caused, for example, by an operator inadvertently spilling a liquid on platen 12, or by some other transient and anomalous event, controller 26 is programmed to alert an operator, such as by illuminating a “check grill” light. In any case, when cooking is complete, controller 26 is then preferably programmed by default to shut off input power to heating elements 18, at which point a light or sound alert may be triggered to prompt an operator to remove the cooked food item from contact with cooking surface 14. Optionally, where the cooking device is a clamshell grill as is cooking device 10 in the illustrated embodiment shown in FIG. 1, controller 26 may direct cooking device 10 to lift upper platen 13 automatically, so that an operator may remove food item(s) H from cooking surface 14.

When food item H has been removed following the end of a cooking sequence, if another cooking sequence is not to follow immediately, input power to heating elements 18 remains shut off. If instead another cooking sequence is to follow immediately, the microprocessor may be programmed to estimate the heat stored in the platen at the end of the previous cooking sequence by extrapolating an estimated temperature profile and calculating an estimate of heat stored as described above. If the heat stored in platen 12 is less than the heat stored in the ready-for-cooking steady state, the microprocessor will then resume feedback control of the power level of heating elements 18 according to the second scenario (startup after partial cool down). If, on the other hand, the heat stored in platen 12 following the previous cooking sequence is greater than the heat stored in the ready-for-cooking steady state, the microprocessor will shut off input power to heating elements 18 until the heat stored is equal to the heat stored in the ready-for-cooking steady state, and then controller 26 will resume the ready-for cooking steady state power level of heating elements 18.

It will also be understood that the programming of a controller to determine whether to supply output power from a heat source, and if so how much power, may be simpler than that described above. For example, in some cases, a controller need not explicitly determine or estimate the amount of heat stored in a platen at any particular time. Rather, in one embodiment, the controller may simply store or be programmed with an interior set-point temperature that is slightly higher than the temperature at an interior location in the platen corresponding to a ready-for-cooking steady state of the platen. Whenever the cooking device is turned on, the controller may be programmed to direct heat to be supplied at a power level of Q_{gen, startup} that is higher than Q_{gen, RFC} for the platen until the interior set-point temperature is reached, and then to reduce the output power level to Q_{gen, RFC}.

Certain decision functions of the controller may also rely on received surface temperature measurements. One very simple example is that a visual or auditory ready alert, such as a light or tone, may be triggered when the measured surface temperature reaches the RFC surface temperature, to alert an operator that a food item may be placed on the platen cooking surface. Then, a sudden drop in surface temperature near where the food item is placed may trigger the commencement of a cooking sequence. Also, to facilitate monitoring the start-up process, the controller may store an expected surface temperature, or an interval within which the surface temperature is expected to fall, for all interior temperatures within the normal operating range of the cooking device. The expected surface temperature or interval may also depend on other factors in addition to the interior temperature, especially including whether the platen was fully cooled off when the cooking device was turned on, and if the platen was only partially cooled off, what the initial interior temperature was when the cooking device was turned on, as the initial temperature profile of the platen may significantly affect the subsequent shape of the temperature profile corresponding to a given subsequent interior temperature. The expected surface temperature or interval may be independently determined, analytically or experimentally, for all relevant sets of parameters, and manually stored in a memory of the controller, or the controller may be programmed with a formula to predict expected surface temperature based on the relevant parameters. Regardless of whether the expected surface temperature is provided to or calculated by the controller, when the cooking device is on and the measured surface temperature differs from the expected surface temperature or falls outside the expected interval, given the current interior temperature, initial interior temperature, and any other relevant known parameters, by more than a permitted amount, the controller may trigger an alert and/or an appropriate corrective action. For example, the controller may turn off the heat source and instruct a device operator to remove an item from the platen surface that could be causing the anomalous surface temperature, for example, and only turn the heat source back on when a subsequent surface temperature measurement indicates that the item has been removed.

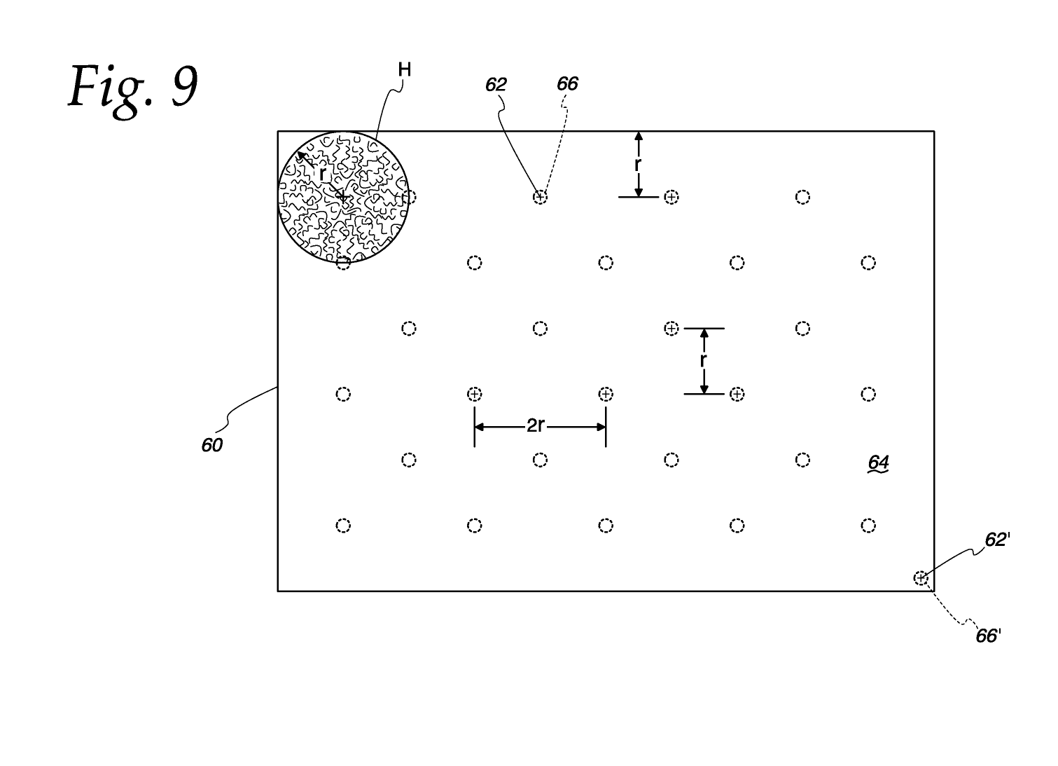

With reference to FIG. 9, a cooking platen 60 having an alternative sensor arrangement for use in cooking devices and methods according to another embodiment of the invention is illustrated in plan view. In particular, cooking platen 60 is configured for sensing surface temperatures at multiple surface locations 62 on a cooking surface 64 of cooking platen 60. Thus, in the illustrated example, a plurality of surface temperature sensors 66 are disposed proximate to multiple corresponding surface locations 62, all of temperature sensors 66 being communicatively linked to a microprocessor (not shown). Alternatively, though not shown, surface temperatures at multiple locations on the cooking surface of a cooking platen could be measured by a single no-touch temperature sensor at a single location disposed remotely from all of the surface locations targeted for temperature measurement. An interior temperature sensor (not shown) may also be disposed in the interior of cooking platen 60 in a similar manner to that described above for single-surface temperature sensor embodiments. Preferably, at least one control surface location 62′ corresponding to at least one temperature sensor 66′ is disposed at an area on cooking surface 64 where food items are typically not placed, for example near a corner or edge of cooking surface 64, and at least one surface location 62 is disposed at an area on cooking surface 64 where food items typically are placed, likely at a more interior location than surface location 62′. More particularly, it may be desirable to distribute a plurality of surface locations 62 evenly over the area of cooking surface 64 where food items may be placed for cooking, so as to enable the measurement of a temperature at or near where a food item H is contacting cooking surface 64, regardless of where on platen 60 food item H is placed. For example, where food item H has a radius or half-width r, it may be desirable to distribute surface locations 62 in a diamond array of diagonal length 2r, such that no point on cooking surface 64 is further than r from the nearest surface location 62 or from an edge of cooking surface 64, as seen in FIG. 9. In this manner, no matter where the center of food item H is located on cooking surface 64, some part of food item H will touch or lie proximate to a surface location 62 so as to affect the temperature at surface location 62.

Methods of controlling the output power level of a heat source of platen 60 may be substantially similar to those described above with respect to feedback process 44 as described above with respect to a single-surface sensor embodiment, except that, instead of taking only one surface temperature measurement and an interior temperature measurement, multiple surface temperature measurements are taken, and an interior temperature measurement may optionally be taken as well. As a result of multiple surface temperature measurements being taken, certain types of derived data, which could not be derived from only a single surface temperature measurement, are also added as possible inputs to decision step 50 that may be factored into the determination of whether and how to adjust the output power level of a heat source of platen 60. For example, given multiple surface temperature measurements, a controller may be able to infer not only whether a food item is present, but how many food items are present, based on which of surface locations 62 have significantly lower measured temperatures than others of surface locations 62 and surface location 62′. The number of food items present on cooking surface 64, determined in this manner, may thus be an additional input variable available for decision step 50. Also, one or more sample statistics derived from the plurality of surface temperature measurements taken at surface locations 62, 62′, including but not limited to a sample mean, median, mode, and/or standard deviation, may be included as inputs to decision step 50.

In a method of cooking a food item using alternative cooking platen 60, the microprocessor can detect the presence of a food item to be cooked contacting cooking surface 64 at or near one of surface locations 62 by detecting a significantly lower temperature at one or more of surface locations 62 than at surface location 62′, indicating that one or more food items is/are contacting cooking surface 64 at or near one or more of surface locations 62.

In a method according to one embodiment, when the presence of a food item is detected in this manner, the microprocessor may be programmed to check whether HE_{stored} of cooking platen 60 is at or near the value of HE_{stored, RFC} for cooking platen 60. The microprocessor may perform this check by determining HE_{stored} in one or more ways, such as by calling up interior and surface temperature readings recorded and stored in a memory just before the temperature difference between surface location 62 and surface location 62′ was detected, and extrapolating a temperature profile from those readings. Alternatively or additionally, the microprocessor may recall a value of a finite approximation of HE_{stored} recorded and stored at the same instant just prior to the detected food contact, which may for example have been calculated as in equation (2) above or by a similar method. If the resulting estimate(s) of HE_{stored} is/are at or near HE_{stored, RFC}, the microprocessor may be programmed to automatically commence a cooking cycle. If not, the microprocessor may trigger an alert to restaurant staff that a food item has been placed on a cooking platen that was not properly heated up, so that restaurant staff may take appropriate corrective action. In other embodiments, the microprocessor may simply check whether the temperature at one or more of surface locations 62, 62′ immediately before the presence of the food item was detected was at or near the desired cooking surface temperature and/or whether an interior temperature is at or near its RFC value, if so, commence a cooking cycle, and if not, trigger the appropriate alert.

In another embodiment, where a cooking device using alternative cooking platen 60 comprises a heat source with multiple heating zones, a cooking sequence may be initiated for only a heating zone in which the presence of a food item is detected in the manner described above.

While the invention has been described with respect to certain embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A temperature-controlled cooking device comprising
a cooking platen having a cooking surface;
a heat source for directing heat energy into the cooking platen;
at least one surface temperature sensor configured to measure a temperature at a location on or proximate to the cooking surface;
at least one internal temperature sensor configured to measure a temperature in the interior of the cooking platen; and
a controller configured to receive at least one measurement of the temperature of at least one platen surface location from the at least one surface temperature sensor and at least one measurement of the temperature of at least one platen interior location from the at least one internal temperature sensor, the controller being programmed to determine an output power level for the heat source from input data including the surface and interior temperature measurements and to control the heat source according to the determined output power level.

2. The device of claim 1, the input data further including at least one parameter selected from the group consisting of a past platen interior temperature measurement, a time interval between platen interior temperature measurements, a measured time rate of change of platen interior temperature, a past platen surface temperature measurement, a time interval between platen surface temperature measurements, a measured time rate of change of platen surface temperature, a sample statistic of a plurality of platen surface temperature measurements, a sample statistic of a plurality of platen interior temperature measurements, an expected surface temperature given a measured platen interior temperature, an expected platen interior temperature given a measured platen surface temperature, a current power level of the heat source, a past power level of the heat source, a depth of the at least one surface location, a horizontal position of the at least one surface location, a depth of the at least one interior location, a horizontal position of the at least one interior location, a thermal conductivity of the platen, a specific heat of the platen, a thickness of the platen, an area of the cooking surface, a volume of the platen, a density of the platen, and a weight per unit area of the platen.

3. The cooking device of claim 1, further comprising a thermally insulating barrier at least substantially covering a surface of the cooking platen generally opposite the cooking surface.

4. The cooking device of claim 1, the cooking surface being a first cooking surface, and the platen further comprising a second cooking surface generally opposite the first cooking surface.

5. The cooking device of claim 1 comprising a plurality of surface temperature sensors configured to measure temperatures at or proximate to a plurality of different locations on the cooking surface.

6. The cooking device of claim 1, the surface temperature sensor configured to measure temperatures at or proximate to a plurality of different locations on the cooking surface.

7. The cooking device of claim 1, the heat source being a heating element configured to transfer heat energy generally conductively to the platen.

8. The cooking device of claim 1, the heat source being configured to transfer heat energy into the platen at a location other than the cooking surface, and the platen configured to conduct at least some of the heat energy to the cooking surface through the interior of the platen.

9. A method of controlling the cooking surface temperature of a cooking platen comprising
providing a cooking device including a cooking platen with a cooking surface, a heat source for directing heat energy into the cooking platen, at least one platen surface temperature sensor, at least one platen internal temperature sensor and a controller; and
causing the controller to receive at least one temperature measurement of at least one platen surface location from the at least one platen surface temperature sensor and at least one temperature measurement of at least one platen interior location from the at least one internal temperature sensor:
determining an output power level for the heat source from input data, the input data including the surface and interior temperature measurements; and
controlling the heat source according to the determined power level.

10. The method of claim 9, further comprising providing a thermally insulating barrier at least substantially covering a surface of the cooking platen generally opposite the cooking surface.

11. The method of claim 9, the cooking surface being a first cooking surface, and the platen further comprising a second cooking surface generally opposite the first cooking surface.

12. A method of cooking a food item on a heated platen surface comprising
providing a cooking device including a cooking platen with a cooking surface, a heat source configured to direct heat energy into the cooking platen, a surface temperature sensor configured to measure a temperature at or proximate to a surface location on the cooking surface, an internal temperature sensor configured to measure a temperature in the interior of the cooking platen, and a controller;
causing the controller, in response to an instruction to start up the cooking device, to receive at least one initial measurement of the platen temperature of at least one platen surface location from the at least one platen surface temperature sensor and at least one initial measurement of the platen temperature of at least one platen interior location from the at least one platen internal temperature sensor, to determine at least one startup power level for the heat source based on the initial platen surface and interior temperature measurements, directing the heat source to add heat to the interior of the cooking platen at the at least one startup power level;
changing the power level of the heat source to another power level when the controller determines that the at least one platen internal temperature measurement and/or the total heat energy stored in the platen has reached a predetermined final start-up threshold, the another power level being an output power level at which the temperature of the platen cooking surface is generally maintained at a predetermined constant ready-for-cooking temperature with no working load;
placing the food item in contact with the platen cooking surface when the at least one platen surface temperature sensor indicates a temperature of the platen cooking surface of approximately the ready-for-cooking temperature; and
causing the controller to direct the heat source to continue to supply heat to the platen at an output power level profile in accordance with a predetermined cooking routine for the food item to cook the food item.

13. The method of claim 12, wherein the at least one startup power level comprises a plurality of startup power levels resulting in an average startup power level greater than the another power level.

14. The method of claim 12 wherein the another power level is a steady state power level.

15. The method of claim 12, further comprising continuously changing the startup power level from the time at which the controller is instructed to start up the cooking device to the time at which the controller determines that the amount of heat energy stored in the platen has reached the final start-up threshold, based on continuous input to the controller from the temperature sensors.

16. The method of claim 12, further comprising causing the controller to automatically detect that a food item to be cooked is in contact with the platen from a sudden drop in the at least one platen surface temperature measurement, and to automatically direct the heat source to commence the predetermined cooking routine for the food item when the food item is detected.

17. The method of claim 12, further comprising causing the controller to automatically detect that a food item to be cooked is in contact with the platen when the at least one platen surface temperature sensor detects a temperature that is lower than an expected surface temperature given data including a sensed platen internal temperature.

18. The method of claim 12, further comprising
providing a plurality of platen surface temperature sensors configured to measure surface temperatures at or proximate to a plurality of different locations on the platen cooking surface; and
causing the controller to automatically detect that a food item to be cooked is in contact with the platen when the platen surface temperature sensors detect at least one surface temperature that differs from at least one other surface temperature by more than a predetermined amount.
